(19) United States
(12) Patent Application Publication
(10) Pub. No.: US 2026/0229012 A1
(43) Pub. Date: Aug. 6, 2026

(54) DETECTION OF SIMULATED IMAGES USING MACHINE LEARNING

(71) Applicant: International Business Machines Corporation, Armonk, NY (US)

(72) Inventors: Kun Yan Yin, Ningbo (CN); Li Ni Zhang, Beijing (CN); Yong Fang Liang, Beijing (CN); Chen Yu Chang, Xian (CN); Pei Jian Liu, Beijing (CN)

(21) Appl. No.: 19/047,028

(22) Filed: Feb. 6, 2025

(51) Int. Cl. G06V 10/764; G06F 40/40; G06V 10/44; G06V 10/74; G06V 10/776; G06V 10/98; G06V 20/70

(52) U.S. Cl. CPC G06V 10/764; G06F 40/40; G06V 10/44; G06V 10/761; G06V 10/776; G06V 10/993; G06V 20/70

(57) ABSTRACT

Detecting simulated images using machine learning includes generating summary data for an input image. First result data is generated from the summary data of the input image. The first result data includes a first set of reasons associated with validation of a representational accuracy of the input image. A first machine learning model is applied on the summary data and the input image. A set of images is generated based on the application of the first ML model. Second result data is generated based on the average similarity score. The first result data and the second result data are combined. Final result data is generated based on the combination of the first result data and the second result data. The input image is detected as a simulated image or a real image based on the final result data.

### BACKGROUND

The disclosure relates to the field of artificial intelligence (AI), and more particularly, to the detection of simulated images.

Simulated images are increasingly prevalent in diverse domains such as entertainment, education, marketing, and digital arts. This growing trend is driven in part by the rapid advancements in technology, particularly in the fields of machine learning and artificial intelligence. Advanced machine learning models enable the creation of simulated but realistic images that closely mimic real-world imagery, achieving a level of quality that renders these images indistinguishable from images captured by sensors.

### SUMMARY

In various embodiments of the disclosure, a computer-implemented method for detecting simulated images using machine learning is provided. The computer-implemented method includes generating, by a computer, summary data for an input image. The computer-implemented method further includes generating, by the computer, first result data based on the summary data. The first result data includes a first set of reasons associated with validation of a representational accuracy of the input image. The computer-implemented method further includes applying, by the computer, a first machine learning (ML) model on the summary data and the input image. The computer-implemented method further includes generating, by the computer, a set of images based on the application of the first ML model on the summary data and the input image. The computer-implemented method further includes generating, by the computer, second result data based on an average similarity score associated with a comparison of the input image with each image in the generated set of images. The computer-implemented method further includes combining, by the computer, the first result data and the second result data to generate final result data. The computer-implemented method further includes outputting, by the computer, the final result data.

In various embodiments of the disclosure, a computer system for detecting simulated images using machine learning is provided. The computer system includes a processor set, one or more computer-readable storage media, and program instructions stored on one or more computer-readable storage media. The program instructions are executable by the processor set to cause the processor set to generate summary data for an input image. The program instructions further cause the processor set to generate first result data based on the summary data. The first result data includes a first set of reasons associated with validation of a representational accuracy of the input image. The program instructions further cause the processor set to apply a first machine learning (ML) model on the summary data and the input image. The program instructions further cause the processor set to generate a set of images based on the application of the first ML model on the summary data and the input image. The program instructions further cause the processor set to generate second result data based on an average similarity score associated with a comparison of the input image with each image in the generated set of images. The program instructions further cause the processor set to analyze the input image based on a set of quality indicators associated with a set of features of the input image. The program instructions further cause the processor set to generate a set of ratings for the set of quality indicators. Each rating of the set of ratings is indicative of a presence of a corresponding quality indicator in the input image. The program instructions further cause the processor set to generate third result data based on the set of ratings. The program instructions further cause the processor set to combine the first result data, the second result data, and the third result data to generate final result data. The program instructions further cause the processor set to output the final result data.

In various embodiments of the disclosure, a computer program product for detecting simulated images using machine learning is provided. The computer program product includes one or more computer-readable storage media. The program instructions are stored on one or more computer-readable storage media to perform operations. The operations include generating summary data for the input image. The operations further include generating first result data based on the summary data. The first result data includes a first set of reasons associated with validation of a representational accuracy of the input image. The operations further include applying a first machine learning (ML) model on the summary data and the input image. The operations further include generating a set of images based on the application of the first ML model on the summary data and the input image. The operations further include generating second result data based on an average similarity score associated with a comparison of the input image with each image in the generated set of images. The operations further include combining the first result data and the second result data to generate final result data. The operations further include classifying the input image as one of the real image or the simulated image based on the final result data. The operations further include outputting the classified input image.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for detection of simulated images using machine learning, in accordance with an embodiment of the disclosure;

FIG. 2 is a diagram that illustrates a network environment for detection of simulated images using machine learning, in accordance with an embodiment of the disclosure;

FIG. 3A is a diagram that illustrates exemplary operations for generation of first result data for detection of simulated images using machine learning, in accordance with an embodiment of the disclosure;

FIG. 3B is a diagram that illustrates exemplary operations for generation of second result data for detection of simulated images using machine learning, in accordance with an embodiment of the disclosure;

FIG. 3C is a diagram that illustrates exemplary operations for generation of third result data for detection of simulated images using a machine learning model, in accordance with an embodiment of the disclosure;

FIG. 3D is a diagram that illustrates first exemplary operations for generation of final result data for detection of simulated images using machine learning, in accordance with an embodiment of the disclosure;

FIG. 3E is a diagram that illustrates second exemplary operations for generation of final result data based on one or more criteria the detection of simulated images using machine learning, in accordance with an embodiment of the disclosure;

FIG. 4A is a diagram that illustrates an exemplary first user interface for detection of simulated images using machine learning, in accordance with an embodiment of the disclosure;

FIG. 4B is a diagram that illustrates an exemplary second user interface for detection of simulated images using machine learning, in accordance with an embodiment of the disclosure;

FIG. 5 is a diagram that illustrates a flowchart of an exemplary first method for detection of simulated images using machine learning, in accordance with various embodiments of the disclosure;

FIGS. 6A and 6B are diagrams that collectively illustrates a flowchart of an exemplary second method for detection of simulated images using machine learning, in accordance with various embodiments of the disclosure.

### DETAILED DESCRIPTION

The growing prevalence of generative AI technologies has led to the production of realistic images. These images are often indistinguishable from human-captured images, blending into a wide range of digital environments. Modern AI image generation models, like those based on advanced generative adversarial networks (GANs) or diffusion models, produce images with a high degree of realism that mimic natural variations in visual details very well. Simulated images are utilized in tasks ranging from creating visual content to enhancing user experiences on digital platforms. The development of AI image-generation technologies has revolutionized digital media by reducing the time and effort to create visual content. Simulated images are adaptable and have contributed to their widespread adoption in the technology fields, such as virtual reality, augmented reality, and metaverse applications.

The increase in the generation of realistic simulated images by the modern image generation model raises a concern about the different forms of misuse such as misinformation and deception, intellectual property theft, impersonation and identity fraud, manipulation of evidence, and academic fraud. The realism associated with the simulated images generated by the modern generative models may be a cause for various types of losses of an individual or a group of people related to fields such as media, law enforcement, academia, and intellectual property management.

The existing simulated image detection models rely on identifying these traditional markers such as watermarking, irregularities in texture, blurriness, or unnatural distortions and primarily analyze visual embeddings of the image such as shape, color, texture, composition, or size. The existing simulated image detection models are based on analyzing and extracting the pixel-level embeddings of the image and classifying the image as a simulated image or real image. The degree of realism and mimicking of the natural variations by the simulated images makes these visual cues less pronounced. Moreover, existing methods overlook contextual and semantic inconsistencies. Hence, the existing detection process might not be able to indicate an image is simulated only based on the extraction of the pixel-level embeddings.

To address these issues, there is a need for an image detection method that focuses on understanding the content and semantics of the image. This involves checking whether the content of the image makes sense logically, such as verifying whether the objects and their interactions align with real-world physics and social norms. Analyzing just the pixel-level embeddings of the image may provide an incorrect classification. Performing a contextual analysis simplifies the examination of the image, aiding the system in identifying any unrealistic details that may enhance the likelihood of the image being a simulated image.

The various embodiments aims to provide a method for detecting simulated images using a multi-modal language model. The method includes extracting the key objects and extracting the summary data of the input image to represent the input image and a large model determines whether the summary data of the input image is reasonable. The first result data is generated based on the determination that the summary data is reasonable. The first result data represents whether the original image is simulated or real based on the summary data. The method further includes generating different simulated images based on the summary data of the input image and determining the similarity between the simulated images and the original image. The second result data is generated based on the determination of similarity between the original image and the simulated images. The second result data represents whether the original image is simulated or real based on the similarity between the original image and the simulated images. The method further includes checking the quality of the original image based on the vision methods. The third result data is generated based on the quality check of the image. The third result data represents whether the original image is simulated or real based on the quality of the original image. The method further includes generating final result data based on the combination of the first result data, the second result data, and the third result data. The final result data represents whether the original image is simulated or real. The method further includes classifying the image as the simulated image or the real image based on the final result data. This overall workflow allows an enhanced analysis of the image over the existing image detection models. The detection of simulated images based on the combination of first result data, the second result data, and the third result data provides comprehensive image analysis over the traditional visual-based methods for the detection of simulated images. Therefore, the accuracy of the detection of the simulated images by the disclosed system is more than that of the traditional techniques that are known in the art as the traditional techniques rely on identifying these traditional markers and primarily analyze visual features whereas the disclosed system is more sophisticated, and further focus on understanding the context and semantics of the image. Furthermore, the disclosed system checks whether the content of the image makes sense logically, such as verifying whether the objects and their interactions align with real-world physics and social norms. Such issues may not be visually apparent but can be detected through contextual analysis as done by the disclosed system. Therefore, the disclosed system is more reliable than the traditional techniques known in the art.

The disclosed system for detecting simulated images using machine learning presents various practical applications and advantages. By ensuring the authenticity of images, various organizations such as news outlets can maintain public trust and credibility, thereby reducing the spread of misinformation. This fosters a sense of confidence among users, who can rely on the system to accurately identify deceptive, simulated images. Furthermore, the disclosed system protects original works from being misrepresented, or sold as simulated generated images, ensuring that creators receive proper recognition and compensation for the efforts done by the creators. Moreover, companies can also utilize the disclosed system to safeguard their visual assets and marketing materials from unauthorized duplication and misuse, thereby preserving brand integrity. In academic environments, the disclosed system can detect AI-generated images in submissions, thereby upholding research integrity, preventing academic fraud, and ensuring that the data used in studies is authentic. This approach maintains the credibility of scientific findings and enhances the reliability of research outcomes. Overall, the benefits of the disclosed system extend far beyond simple image analysis. It plays a crucial role in fostering trust, protecting intellectual property, and upholding ethical standards across various fields.

In various embodiments, the disclosed system utilizes machine learning models to determine the logic of the image and a set of vision algorithms to analyze the visual embeddings of the image. The logic of the image refers to how the objects within the image are organized and contribute to conveying meaning or a narrative with respect to the real world. The holistic evaluation of both the logic and visual embeddings provides a comprehensive analysis of images that are visually realistic but logically inconsistent. The disclosed system may detect subtle discrepancies in the image based on the visual embeddings associated with the image. The method provides an explanation to the users and allows them to understand what aspects of the image were assessed to drive the specific logical inconsistencies.

Various embodiments of the disclosure offer advantages in mitigating potential risks associated with undisclosed AI-generated images (also referred to as simulated images). By ensuring the authenticity of images, the disclosed system helps agencies such as, but not limited to, news outlets to maintain public trust and credibility, thereby reducing the spread of misinformation. Users may engage with content, knowing that deceptive simulated visuals are identified. The system protects original works from being copied and sold as simulated images, ensuring that creators receive proper recognition and compensation. Additionally, the detection of simulated images in academic submissions upholds research integrity and prevents academic fraud. By ensuring the authenticity of data and images used in research, various embodiments of the disclosure further reinforce the credibility and reliability of scientific findings.

In various embodiments of the disclosure, a computer-implemented method for detection of simulated images using machine learning is described. The computer-implemented method includes generating, by a computer, summary data for an input image. The computer-implemented method further includes generating, by the computer, first result data based on the summary data. The first result data includes a first set of reasons associated with validation of a representational accuracy of the input image. The computer-implemented method further includes applying, by the computer, a first machine learning (ML) model on the summary data and the input image. The computer-implemented method further includes generating, by the computer, a set of images based on the application of the first ML model on the summary data and the input image. The computer-implemented method further includes generating, by the computer, second result data based on an average similarity score associated with a comparison of the input image with each image in the generated set of images. The computer-implemented method further includes combining, by the computer, the first result data and the second result data to generate final result data. The computer-implemented method further includes outputting, by the computer, the final result data.

In various embodiments of the disclosure, the computer-implemented method further includes identifying, by the computer, a set of positions associated with a set of objects in the input image. The computer-implemented method further includes generating, by the computer, the summary data of the input image based on the identification of the set of positions associated with the set of objects in the input image. The computer-implemented method further includes applying, by the computer, a second machine learning model on the summary data. The computer-implemented method further includes generating, by the computer, the first set of reasons based on the application of the second machine learning model on the summary data.

In various embodiments of the disclosure, the first result data further includes at least one of a label assigned to the input image or a first score associated with the assignment of the label to the input image.

In various embodiments of the disclosure, the label is indicative of the input image being one of a real image or a simulated image.

In various embodiments of the disclosure, the computer-implemented method further includes generating, by the computer, an input embedding associated with the input image. The computer-implemented method further includes generating, by the computer, a set of embeddings associated with the generated set of images. The computer-implemented method further includes calculating, by the computer, a similarity score indicative of a similarity between the input embedding and each embedding of the set of embeddings. The computer-implemented method further includes calculating, by the computer, the average similarity score indicative of the similarity between the input image and the set of images based on the calculated similarity score between the input embedding and each embedding of the set of embeddings. The computer-implemented method further includes generating, by the computer, the second result data based on the calculated average similarity score.

In various embodiments of the disclosure, the second result data includes at least one of a label assigned to the input image, a second score associated with the assignment of the label to the input image, or a second set of reasons associated with the assignment of the label to the input image.

In various embodiments of the disclosure, the computer-implemented method further includes applying, by the computer, one or more pre-processing operations on the input image. The computer-implemented method further includes extracting, by the computer, a set of features from the input image based on the application of the one or more pre-processing operations on the input image. The computer-implemented method further includes analyzing, by the computer, the input image based on a set of quality indicators associated with the set of features. The computer-implemented method further includes generating, by the computer, a set of ratings for the set of quality indicators. Each rating of the set of ratings is indicative of a presence of a corresponding quality indicator of the set of quality indicators in the input image. The computer-implemented method further includes generating, by the computer, third result data based on the set of ratings.

In various embodiments of the disclosure, the third result data includes at least one of a label assigned with the input image, a score associated with the assignment of the label to the input image, or a third set of reasons associated with the assignment of the label to the input image.

In various embodiments of the disclosure, the computer-implemented method further includes generating, by the computer, a prompt based on the first result data, the second result data, the third result data, and one or more criteria. The computer-implemented method further includes applying, by the computer, a language model to the generated prompt. The computer-implemented method further includes determining, by the computer, the final result data based on the application of the language model to the generated prompt. The computer-implemented method further includes outputting, by the computer, the determined final result data.

In various embodiments of the disclosure, the computer-implemented method further includes classifying, by the computer, the input image as one of a real image or a simulated image based on determined final result data. The computer-implemented method further includes outputting, by the computer, the classified input image.

In various embodiments of the disclosure, a computer system for detection of simulated images using machine learning is described. The computer system includes a processor set, one or more computer-readable storage media, program instructions stored on the one or more computer-readable storage media. The program instructions are executable by the processor set and cause the processor set to generate summary data for an input image. The program instructions further cause the processor set to generate first result data based on the summary data. The first result data includes a first set of reasons associated with validation of a representational accuracy of the input image. The program instructions further cause the processor set to apply a first machine learning (ML) model on the summary data and the input image. The program instructions further cause the processor set to generate a set of images based on the application of the first ML model on the summary data and the input image. The program instructions further cause the processor set to generate second result data based on an average similarity score associated with a comparison of the input image with each image in the generated set of images. The program instructions further cause the processor set to analyze the input image based on a set of quality indicators associated with a set of features of the input image. The program instructions further cause the processor set to generate a set of ratings for the set of quality indicators. Each rating of the set of ratings is indicative of a presence of a corresponding quality indicator in the input image. The program instructions further cause the processor set to generate third result data based on the set of ratings. The program instructions further cause the processor set to combine the first result data, the second result data, and the third result data to generate final result data. The program instructions further cause the processor set to output the final result data.

In various embodiments of the disclosure, the program, instructions further cause the processor set to identify a set of positions associated with a set of objects in the input image. The program instructions further cause the processor set to generate the summary data of the input image based on the identification of the set of positions associated with the set of objects in the input image. The program instructions further cause the processor set to apply a second machine learning model to the summary data. The program instructions further cause the processor set to generate the first set of reasons based on the application of the second machine learning model on the summary data.

In various embodiments of the disclosure, the first result data further includes at least one of the label assigned to the input image or a score associated with the assignment of the label to the input image.

In various embodiments of the disclosure, the label is indicative of the input image being one of a real image or simulated image.

In various embodiments of the disclosure, the program instructions further cause the processor set to generate an input embedding associated with the input image. The program instructions further cause the processor set to generate a set of embeddings associated with the generated set of images. The program instructions further cause the processor set to calculate a similarity scores indicative of a similarity between the input embedding and each embedding of the set of embeddings. The program instructions further cause the processor set to calculate a similarity scores indicative of a similarity between the input embedding and each embedding of the set of embeddings. The program instructions further cause the processor set to calculate the average similarity score indicative of the similarity between the input image and the set of images based on the calculated similarity score between the input embedding and each embedding of the set of embeddings. The program instructions further cause the processor set to generate the second result data based on the calculated average similarity score.

In various embodiments of the disclosure, the second result data includes at least one of a label assigned to the input image, a score associated with the assignment of the label to the input image, or a set of reasons associated with the assignment of the label to the input image.

In various embodiments of the disclosure, the program instructions further cause the processor set to apply one or more pre-processing operations on the input image. The program instructions further cause the processor set to extract the set of features based on the application of the one or more pre-processing operations on the input image. The program instructions further cause the processor set to analyze the input image based on the set of quality indicators associated with the set of features. The program instructions further cause the processor set to generate a set of ratings for the set of quality indicators. The program instructions further cause the processor set to generate the third result data based on the set of ratings.

In various embodiments of the disclosure, the third result data includes at least one of a label assigned with the input image, a score associated with the assignment of the label to the input image, or a set of reasons associated with the assignment of the label to the input image.

In various embodiments of the disclosure, the program instructions further cause the processor set to generate a prompt based on the first result data, the second result data, the third result data, and one or more criteria. The program instructions further cause the processor set to apply a language model on the generated prompt. The program instructions further cause the processor set to determine the final result data based on the application of the language model on the generated prompt. The program instructions further cause the processor set to classify the input image as one of a real image or a simulated image based on determined final result data. The program instructions further cause the processor set to output the classified input image.

In various embodiments of the disclosure, a computer program product for data quality estimation using machine learning (ML) model is described. The computer program product includes one or more computer-readable storage media and program instructions stored in the one or more computer-readable storage media to perform operations that include generating summary data for an input image. The operations further include generating first result data based on the summary data. The first result data includes a first set of reasons associated with validation of a representational accuracy of the input image. The operations further include applying a first machine learning (ML) model on the summary data and the input image. The operations further include generating a set of images based on the application of the first ML model on the summary data and the input image. The operations further include generating second result data based on an average similarity score associated with a comparison of the input image with each image in the generated set of images. The operations further include combining the first result data and the second result data to generate the final result data. The operations further include classifying the input image as one of the real image or the simulated image based on the final result data. The operations further include outputting the final result data.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations may be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that may retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or transmission media. As will be understood by those of skill in the art, data is typically moved at some occasional points in time during normal operation of a storage device, such as during access, de-fragmentation, or garbage collection, but this does not render the storage device as transitory because the data is not transitory while data is stored.

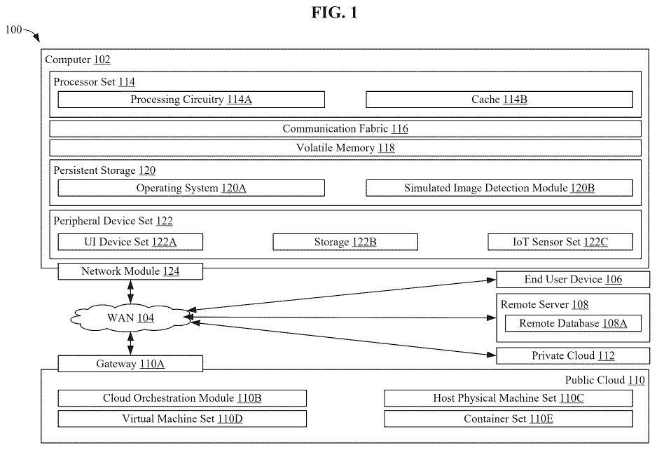

FIG. 1 is a diagram that illustrates a computing environment for prediction and prevention of cybersquatting events, in accordance with various embodiments of the disclosure. With reference to FIG. 1, there is shown a computing environment 100 that contains an example of an environment for the execution of at least some of the computer code involved in performing the inventive methods, such as simulated image detection module 120B. In addition to the simulated image detection module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the simulated image detection module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. Alternatively, in this presentation of the computing environment 100, detailed discussion is focused on a single computer, specifically the computer 102, to keep the presentation as simple as possible. The computer 102 may be located in a cloud, even though the computer 102 is not shown in a cloud in FIG. 1.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 114B and the storage media discussed below. The program instructions, and associated data, are accessed by the processor set 114 to control and direct the performance of the inventive methods. In computing environment 100, at least some of the instructions for performing the inventive methods may be stored in the dynamic modification of the simulated image detection module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 may be characterized by a random access. In the computer 102, the volatile memory 118 may be located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the simulated image detection module 120B typically includes at least some of the computer code involved in performing the inventive methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 may comprise an amount of storage (for example, where computer 102 locally stores and manages a database) then this storage may be provided by peripheral storage devices designed for storing data, such as a storage area network (SAN) that is shared by multiple, geographically distributed computers. The IoT sensor set 122C is made up of sensors that may be used in Internet of Things applications. For example, one sensor may be a thermometer, and one sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods may typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. Virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the r hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a hybrid cloud.

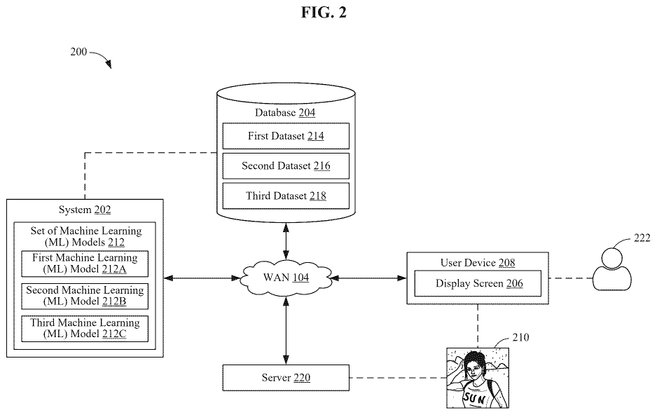

FIG. 2 is a diagram that illustrates a network environment 200 for detection of simulated images using machine learning, in accordance with various embodiments of the disclosure. FIG. 2 is explained in conjunction with elements from FIG. 1. With reference to FIG. 2, there is shown a diagram of a network environment 200. The network environment 200 includes a system 202 (also referred to as a computer system), a database 204, a display screen 206 within a user device 208, an input image 210 and a set of machine learning (ML) models 212. There is further shown a first dataset 214, a second dataset 216, a third dataset 218, and a server 220. The network environment 200 further includes a first entity 222 associated with the user device 208. The set of machine learning (ML) models 212 includes a first ML model 212A, a second ML model 212B, and a third ML model 212C. The network environment 200 further includes the WAN 104 of FIG. 1. In various embodiments of the disclosure, the user device 208 may be an exemplary embodiment of the EUD 106. Similarly, the system 202 may be an exemplary embodiment of the computer 102 in FIG. 1.

The system 202 may include suitable logic, circuitry, interfaces, and/or code that may be configured for detection of simulated image using machine learning models. The system 202 may be configured to generate summary data for the input image 210. The system 202 may be configured to generate first result data based on the summary data for the input image 210. The system 202 may be further configured to apply the first ML model 212A of the set of machine learning (ML) models 212. The system 202 may be further configured to generate a set of images based on the application of the first ML model 212A of set of ML models 212 on the summary data and the input image 210. The system 202 may be further configured to generate second result data based on the average similarity score between the input image 210 with each image in the set of images. The system 202 may be further configured to combine the first result data and the second result data to generate final result data. The system 202 may be further configured to output the final result. Examples of the system 202 may include, but are not limited to, a server, a computing device, a virtual computing device, a mainframe machine, a computer workstation, a smartphone, a cellular phone, a mobile phone, a gaming device, or a consumer electronic (CE) device.

The user device 208 may include suitable logic, circuitry, interfaces, and/or code that may be configured to receive the input image 210 from the first entity 222 and transmit the received first input to the system 202. In various embodiments, the user device 208 may be further configured to render final result data received from the system 202 on a display screen 206 associated with the user device 208. In various embodiments, the user device 208 may include a display screen 206. In various embodiments, the first entity 222 may correspond to a stand-alone user or an organization. Examples of the user device 208 may include, but are not limited to, a computing device, a mainframe machine, a server, a computer work-station, a smartphone, a cellular phone, a mobile phone, a gaming device, a consumer electronic (CE) device, a head-mounted device, a virtual reality (VR) headset, an augmented reality (AR) Device, a mixed reality (MR) Device, a projection-based system, and/or any other device with computer vision display capabilities.

The display screen 206 may include suitable logic, circuitry, and interfaces that may be configured to render the generated result. In some embodiments of the disclosure, the display screen may be an external display device associated with the user device 208. The display screen may be a touch screen which may enable the first entity 222 to provide the first input via the display screen 206. The touch screen may be at least one of a resistive touch screen, a capacitive touch screen, or a thermal touch screen. In accordance with various embodiments of the disclosure, the display screen may refer to a display screen of a head-mounted device (HMD), a smart-glass device, a see-through display, a projection-based display, an electro-chromic display, or a transparent display. In some embodiments of the disclosure, the display screen may be realized through several known technologies such as, but are not limited to, at least one of a liquid crystal display (LCD) display, a light emitting diode (LED) display, a plasma display, or an organic LED (OLED) display technology, or various display devices.

The first ML model 212A of the set of ML models 212 may correspond to a computer-based system or software that integrates multimodal capabilities, enabling the first ML model 212A to process and understand multiple types of input data such as text, images, audio, and video. The first ML model 212A may be designed to perform tasks requiring the simultaneous interpretation of different data modalities, such as generating image captions, performing text-to-image synthesis, or conducting multimodal reasoning. Multimodal systems extend beyond single-modal processing and enable a deeper understanding of complex scenarios.

The first ML model 212A may employ advanced architectures and processes that combine natural language processing (NLP) and computer vision (CV) to establish a unified understanding of textual and visual data. For instance, the first ML model 212A may correspond to a text-to-vision model designed to generate realistic visual content from textual descriptions or interpret images based on accompanying text. Certain characteristics of such a multimodal model may include but are not limited to, cross-modal understanding, image generation, multimodal reasoning, and the ability to transfer knowledge across different domains. In an example, the multimodal model may be implemented using architectures such as generative adversarial networks (GANs), diffusion models, or vision-language transformers.

Further, the first ML model 212A may utilize transformer-based architectures to achieve its multimodal capabilities, however, this should not be construed as a limitation. For example, vision-language transformers leverage attention mechanisms to align textual and visual data representations. These architectures utilize shared embedding spaces for textual and visual inputs, enabling models to correlate semantic information from text and visual features. This alignment allows the model to generate coherent images from textual prompts or annotate visual inputs with meaningful textual descriptions.

In various embodiments, a base multimodal model may refer to a pre-trained model trained on large-scale multimodal datasets, encompassing diverse image-text pairs or multimodal tasks such as video-captioning or audio-visual synchronization. The pre-trained model serves as a foundation for capturing broad relationships between different modalities. For example, in the context of transformer-based architectures, a base multimodal model may learn semantic alignment, cross-modal attention, and the shared representation of text and images.

The second ML model 212B of the set of ML models 212 may correspond to a computer-based system or software that exhibits characteristics commonly associated with human visual perception. The second ML model 212B may be designed to perform tasks that typically need human-like vision, such as object detection, image classification, scene understanding, visual reasoning, and decision making based on visual input. Visual-based systems may range from simple rule-based programs to sophisticated, self-learning systems that interpret complex visual data.

The second ML model 212B may be a sophisticated piece of software that leverages computer vision (CV) techniques and machine learning algorithms to process and interpret visual information. For example, the second ML model 212B may correspond to a vision model or a large vision model (LVM) model that is designed for tasks related to visual understanding and generation on a large scale. Certain characteristics of the LVM model may include but are not limited to, object detection, semantic segmentation, image classification, multimodal learning, transfer learning, continuous learning, and user interaction. In an example, the LVM model visual processing may be implemented using convolutional neural network (CNN), vision transformers (ViTs), or hybrid architectures that combine both, and the like.

In various embodiments, the LVM may be a type of ML model specifically designed to understand, process, and generate visual data on a large scale. LVMs may leverage deep learning architecture to analyze images, videos, and various visual inputs. LVMs have gained prominence for their ability to perform a wide range of vision-related tasks, including object detection, scene parsing, image generation, video understanding, and more. Typically, LVMs may be characterized by a vast number of parameters, often ranging from tens of millions to billions, enabling them to capture complex visual patterns and relationships during training.

In various embodiments, the LVMs may be considered to be built on transformer architecture, however, this should not be construed as a limitation. For example, the transformer architecture effectively captures long-range dependencies and contextual information in visual data. Moreover, the transformer architecture may use attention mechanisms to weigh the significance of different regions within an image or video frame. Additionally, the LVMs may employ bidirectional processing, allowing the models to consider context from multiple perspectives when analyzing an image. This bidirectional approach enhances the model's understanding of the spatial and contextual relationships between objects in a scene.

In various embodiments, a base model in an LVM refers to a pre-trained model that has been trained on a large corpus of visual data for a general image language understanding and generation task. The pre-trained model serves as a foundation for capturing broad visual patterns and knowledge from diverse sources. For example, in the context of pre-trained transformers, a base model is pre-trained on a massive dataset to predict the next pixel, object, or visual feature, effectively learning structure, context, and semantics from diverse visual patterns.

The third ML model 212C of the set of ML models 212 may correspond to a computer-based system or software that exhibits characteristics commonly associated with human intelligence. The third ML model 212C may be designed to perform tasks that typically need human intelligence, such as problem-solving, learning, reasoning, perception, understanding natural language, and decision-making. AI systems may range from simple rule-based programs to sophisticated, self-learning systems.

The third ML model 212C may be a sophisticated piece of software that leverages natural language processing (NLP) and machine learning techniques to understand, generate, and manipulate human language. For example, the third ML model 212C may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. In an example, the LLM model for language processing may be implemented using a generative pre-trained transformer (GPT), bidirectional encoder representations from transformers (BERT), and the like.

Further, the LLM may be a type of ML model specifically designed to understand, generate, and manipulate human language on a large scale. LLMs may leverage machine learning techniques, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

In an example, the LLMs may be considered to be built on transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. In an example, the LLMs may generate contextual representations of words, meaning that the representation of a word is influenced by its surrounding context. This enables the model to capture the meaning of words in different contexts.

In various embodiments, a base model in an LLM refers to a pre-trained model that has been trained on a large corpus of data for a general natural language understanding and generation task. The pre-trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

In various embodiments, an adapter refers to a smaller and task-specific module added to the base model to adapt the base model for a particular task or domain. The adapter includes a lightweight set of parameters that is trained on task-specific data while keeping the majority of the base model's parameters frozen. In particular, the adapter is used to fine-tune the base model for a specific downstream task without extensively modifying its pre-trained parameters. This approach is beneficial when computational resources or labeled task-specific data are limited.

The database 204 may be a set of datasets including the first dataset 214, the second dataset 216, and the third dataset 218. Each of the first dataset 214, the second dataset 216, and the third dataset 218 may correspond to an organized collection of data that may be stored and accessed electronically from a computer system (such as the system 202). In various embodiments, the first dataset 214 may be associated with one or more images, such as the input image 210. The second dataset 216 may be associated with the system 202 and may store a training dataset that may be used to train the first ML model 212A. The third dataset 218 may be associated with one or more domain names registered by users such as the first entity 222.

Each of the first dataset 214, the second dataset 216, and the third dataset 218 may be designed to manage, store, retrieve, and update data. The structure of each of the first dataset 214, the second dataset 216, and the third dataset 218 base typically involves tables, records, and fields that may be managed through various database management systems (DBMS).

Examples of each of the first dataset 214, the second dataset 216, and the third dataset 218 may include but are not limited to, as a relational database, a non-structured query language (SQL) database, a hierarchical database, a network database, a transactional database, a data warehouse, and a distributed database.

The server 220 may include suitable logic, circuitry, interfaces, and/or code that may be configured to first registration information and second registration information. The server 220 may be configured to store the first ML model 212A and the second ML model 212B. The server 220 may be implemented as a cloud server and may execute operations through web applications, cloud applications, hypertext transfer protocol (HTTP) requests, repository operations, file transfer, and the like. Various example implementations of the server 220 may include, but are not limited to, a database server, a file server, a web server, a media server, an application server, a mainframe server, or a cloud computing server.

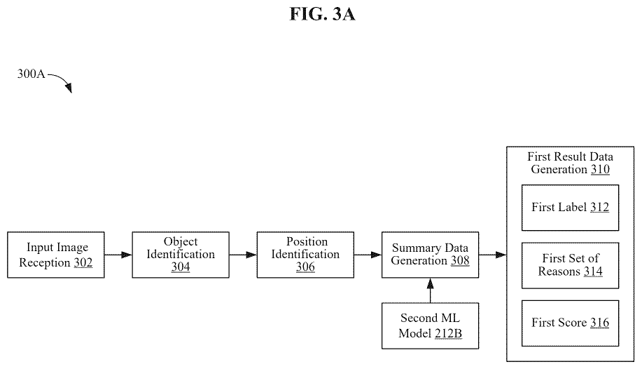

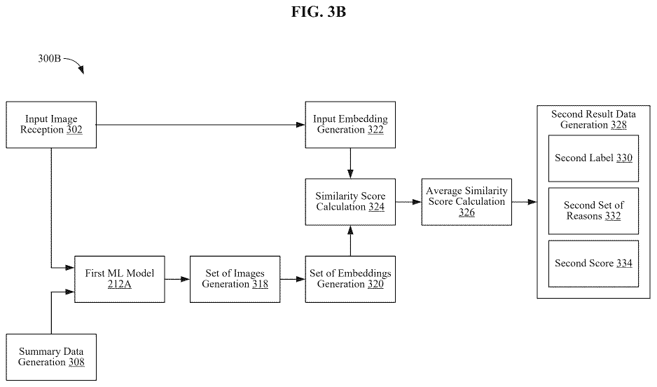

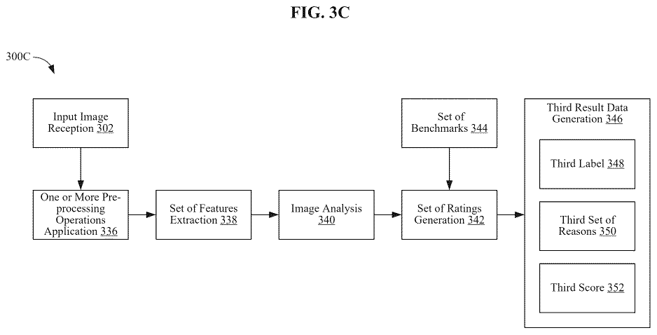

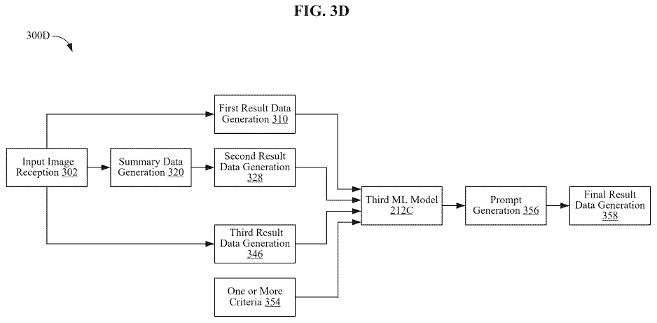

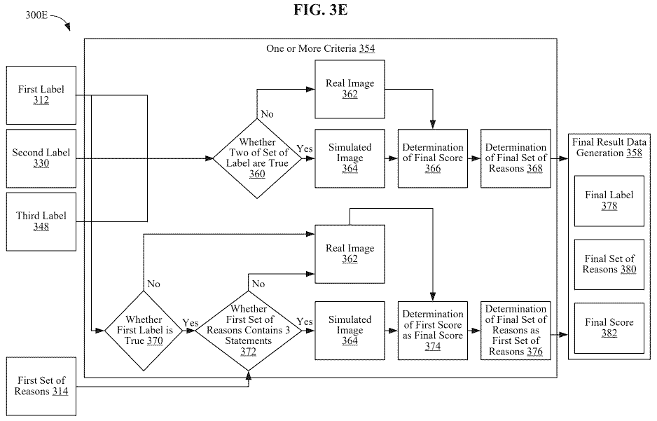

FIG. 3A is a diagram that illustrates exemplary operations for generation of the first result data using machine learning models, in accordance with various embodiments of the disclosure. FIG. 3A is explained in conjunction with elements from FIG. 1, and FIG. 2. With reference to FIG. 3A, there is shown a block diagram 300A that illustrates exemplary operations from 302 to 310, as described herein. The exemplary operations illustrated in the block diagram 300A may start at 302 and may be performed by any computing system, apparatus, or device, such as by the computer 102 of FIG. 1 or system 202 of FIG. 2. Although illustrated with discrete blocks, the exemplary operations associated with one or more blocks of the block diagram 300A may be divided into additional blocks, combined into fewer blocks, or eliminated, depending on the particular implementation.

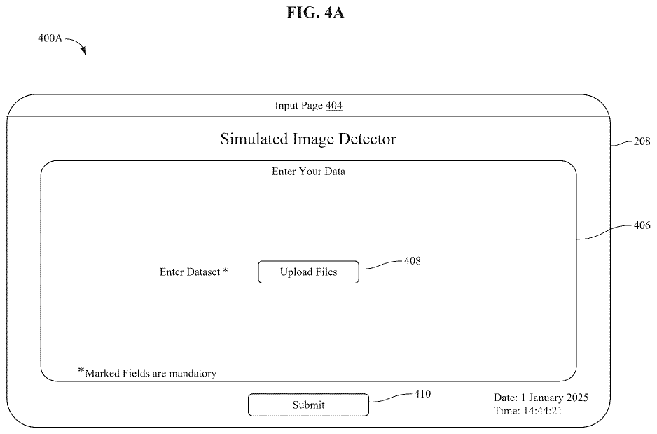

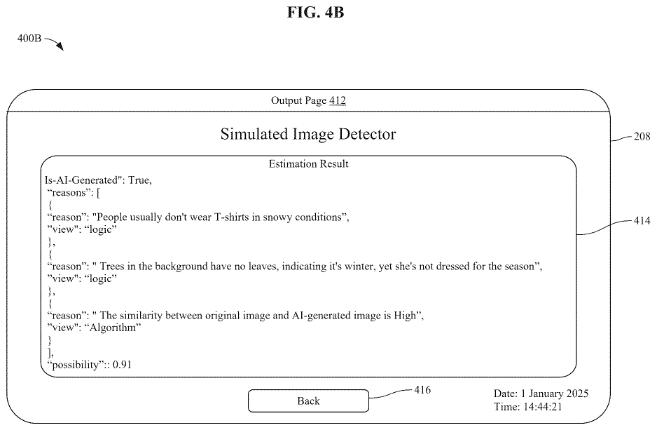

At 302, an input image reception operation is executed. The system 202 may be configured to receive the input image 210. In various embodiments, the input may be received from user device 208 that may be associated with the first entity 222 who may be a registered user. Details about the first input are provided, for example, in FIG. 4A.

In an alternate embodiment, the input image 210 may be received from the first dataset 214 stored in the database 204. The first dataset 214 may include a set of images that includes images of humans, products, identification documents, artwork, digital certificates, medical scans, satellite imagery, engineering blueprints, and the like. Each image from the set of images may be associated with detailed metadata including, but not limited to, timestamps, geographical location, resolution, image format, compression level, color profile, and device-specific information (such as camera model and serial number). For example, product images may include metadata on stock-keeping unit (SKU) numbers, batch codes, or manufacturing dates.

At 304, an object identification operation may be executed. In the object identification operation, the system 202 may be configured to detect a set of objects that may be associated with the input image 210. In various embodiments, the set of objects may include, but are not limited to, physical objects, environmental elements, attributes associated with objects, actions associated with objects, and symbolic elements present in the input image 210. By way of example, where the input image 210 represents a traffic scene, the set of objects may include vehicles, traffic signals, lane markers, and pedestrians in the input image 210.

In various embodiments, the system 202 may be configured to represent each object of the set of objects by a unique tag from a set of tags. For example, where the input image 210 represents a person wearing a training shirt (also referred to as a T-shirt) and posing in the snowstorm, the set of tags may include, but is not limited to, snowstorm, person, hair, head, pose, selfie, t-shirt, snow, wear, and human.

In various embodiments, the system 202 may be configured to perform a set of operations for object detection to generate a set of objects that may be associated with the input image 210. For example, the set of operations may correspond to but is not limited to, the operations corresponding to a recurrent attention model (RAM) designed to identify a set of objects from the input image 210. The RAM iteratively processes the input image 210 by dividing the input image 210 into regions and dynamically focusing on specific areas to refine its understanding of object presence and spatial relationships. The output of the model may include a detailed set of objects, their spatial locations, and contextual relationships, allowing for a comprehensive understanding of the visual input.

At 306, a position identification operation may be executed. In the position identification operation, the system 202 may be configured to detect a set of positions of the set of objects that may be associated with the input image 210 that may be received as the input at 302. In various embodiments, the set of positions may include but are not limited to, spatial coordinates of each object of the set of objects associated with the input image 210. The system 202 may be further configured to generate a boundary box that may represent spatial coordinates for each object of the set of objects.

In various embodiments, the system 202 may be configured to detect a set of positions of the set of objects associated with the input image 210. The system 202 may be configured to represent the position of each object of the set of objects by a boundary box. By way of example, where a position of an object is represented by a boundary box as (x1, y1, x2, y2, x3, y3, x4, y4), x1 represents the x-coordinate of the top-left corner of the object in the input image 210, y1 represents the y-coordinate of the top-left corner of the object in the input image 210, x2 represents the x-coordinate of the top-right corner of the object in the input image 210, y2 represents the y-coordinate of the top-right corner of the object in the input image 210, x3 represents the x-coordinate of the bottom-right corner of the object in the input image 210, y3 represents the y-coordinate of the bottom-right corner of the object in the input image 210, x4 represents the x-coordinate of the bottom-left corner of the object in the input image 210, y4 represents the y-coordinate of the bottom-left corner of the object in the input image 210

In various embodiments, the system 202 may be configured to perform a set of operations for position detection to generate a set of positions that may be associated with the input image 210. For example, the set of operations may correspond to but is not limited to, the operations for detecting the positions of the set of objects in the input image 210 corresponding to a grounding DINO model designed for detecting the positions of the objects in the input image 210. Grounding-DINO is a transformer-based vision model that combines object detection with language grounding, enabling the grounding-DINO model to identify objects and the spatial locations of the identified objects based on textual queries. The model processes the image by generating feature embeddings for the entire scene and then uses the attention mechanism to focus on specific regions relevant to the detected objects. The output of the model includes precise bounding boxes, object labels, and positional data, enabling detailed analysis of object presence and spatial relationships of the set of objects within the image.

At 308, a summary data generation operation is executed. In the summary data generation operation, the system 202 may be configured to generate the summary data of the input image 210 based on the application of the second ML model 212B. The system 202 may be configured to apply a second ML model 212B on the input image 210 and the set of positions of the set of objects associated with the input image 210. In various embodiments, the summary data may include but is not limited to, a set of statements that represent a description of the input image 210. By way of example, and not by limitation the summary data of the input image 210 may include, “The image captures a person standing in a snowy landscape, the person's gaze directed towards the camera with a serious expression on their face. The person is dressed in a white T-shirt that bears the word “SUN” in black letters and a black backpack slung over their shoulders. The person's hair is dark and wet from the snowfall. The background of the image reveals a row of trees blanketed in snow; their branches heavy under the weight of the winter weather. The overall scene paints a picture of a cold, wintry day.”

In various embodiments, the second ML model 212B of the set of ML models 212 may be a language vision model to generate summary data based on the set of positions for the set of objects associated with the input image 210. For example, the second ML model 212B of the set of ML models 212 may correspond to but is not limited to, a large language and vision assistant (LLava) model. The LLava is a transformed-based multimodal model that combines vision transformers (ViT) with language models to generate a detailed description of the input image 210. This model processes both visual and textual data simultaneously to provide natural language summaries based on the content of the input image 210. The input image 210 is first processed by the vision transformer, where the input image 210 is divided into patches, and each patch is transformed into feature representations that capture key information about the image. These embeddings are then fed into a series of attention layers, enabling the model to focus on objects and relationships within the image. During operation, the LLava model dynamically selects and attends to regions of the input image 210, refining its understanding of the scene over multiple iterations. This process enables the model to generate a natural language summary data that captures the content, context, and relationships between the set of objects in the input image 210. The output of the LLava model is a content and human-readable text description that summarizes the key elements of the image, including objects, actions, and spatial relationships.

In various embodiments, the second ML model 212B of the set of ML models 212 on the input image 210 may be trained using a supervised learning approach based on the second dataset 216. The second dataset 216 may be indicative of the annotated images with ground-truth descriptions and image-level summaries. The image-level summaries represent the key content of each image including objects, actions, and relationships, which serve as reference data for the training process. In various embodiments of the disclosure, the system 202 is configured to perform an operation of generating the summary data based on the set of positions of the set of objects associated with the input image 210 based on the application of a plurality of ML models on the input image 210 and the set of positions of the set of objects associated with the input image 210.

At 310, a first result data generation operation is executed. In the first result data generation operation, the system 202 may be configured to generate the first result data based on the summary data generated at 308t. In various embodiments, the first result data may include a first label 312, a first set of reasons 314, and a first score 316.

In various embodiments, the first result data may include the first label 312 that represents a truth value for detecting whether the input image 210 is simulated or real. The first result data may further include the first set of reasons 314. The first result data may further include the first score 316 that represents a confidence value of the second ML model 212B.

In various embodiments, by way of an example, and not by limitation the first result data generated at 312 associated with the input image 210 may be represented as prompt:

```
  {
  ″Is-AI-Generated″: True,
    “reasons”: [″People usually don't wear T-shirts in snowy conditions″, ″Trees in the
    background have no leaves, indicating it's winter, yet the person is not dressed for the
    season″],
    ″possibility″: 0.95
  }
where “Is-AI-Generated″: True” represents the first label 312,
“reasons” represents the first set of reasons 314,
“possibility” represents the first score 316.
```

FIG. 3B is a diagram that illustrates exemplary operations for generation of the second result data using machine learning models, in accordance with various embodiments of the disclosure. FIG. 3B is explained in conjunction with elements from FIG. 1, and FIG. 2. With reference to FIG. 3, there is shown a block diagram 300B that illustrates exemplary operations from 318 to 328, as described herein. The exemplary operations illustrated in the block diagram 300B may start at 318 and may be performed by any computing system, apparatus, or device, such as by the computer 102 of FIG. 1 or the system 202 of FIG. 2. Although illustrated with discrete blocks, the exemplary operations associated with one or more blocks of the block diagram 300B may be divided into additional blocks, combined into fewer blocks, or eliminated, depending on the particular implementation.

At 318, a set of images generation operation may be executed. The system 202 may be configured to generate a set of images based on the application of the first ML model. The system 202 may be configured to apply the first ML model on the input image 210 and the summary data of the input image 210 to generate the set of images. In various embodiments, each image of the set of images may include but is not limited to, an image contextually relevant to the summary data of the input image 210.

In various embodiments, the system 202 may be configured to apply the first ML model 212A on the summary data and the input image 210. Based on the application of the first ML model 212A from the set of ML models 212, the system may generate a set of images. For example, the first ML model 212A of the set of ML models 212 may correspond to but is not limited to, a text-to-vision model to generate a set of images from the summary data of the input image 210. The text-to-vision model leverages a transformer-based architecture that integrates natural language processing with vision synthesis tasks. The text-to-vision model processes the input text through a series of attention layers, analyzing the semantic meaning and contextual relationships between words and phrases. The text is encoded into a sequence of tokens, which are transformed into feature representations. These feature representations are then passed through a multi-head attention mechanism that dynamically aligns the linguistic information with visual attributes. The text-to-vision model iteratively refines the latent visual representation, to generate coherent and contextually relevant images.

In various embodiments, the first ML model 212A of the set of ML models 212 on the summary data of the input image 210 may be trained using a supervised learning approach based on the second dataset 216. The second dataset 216 may be indicative of the annotated pairs of textual descriptions and corresponding images, providing ground-truth visual outputs aligned with specific text input. The training process involves multiple iterations where the model iteratively refines its predictions to enhance detection accuracy. In various embodiments of the disclosure, the system 202 is configured to perform the generation of the set of images operations from the summary data of the input image 210 based on the application of a plurality of ML models on data.

At 320, a set of embeddings generation operation may be executed. In the generation of the set of embeddings, the system 202 may be configured to generate a set of embeddings that may be associated with the set of images generated at 318 based on the summary data of the input image 210 and the input image 210. In various embodiments, each embedding of the set of embeddings may include but are not limited to, a list of numerical values representing numerical encoding of the characteristics of the corresponding image of the set of images.

At 322, an input embedding generation may be executed. In the generation of the input embedding, the system 202 may be configured to generate an input embedding that may be associated with the input image 210 that may be received as the input at 302. In various embodiments, the input embedding may include but is not limited to, a list of numerical values representing numerical encoding of the characteristics of the input image 210.

In various embodiments, the system 202 may be configured to generate a set of embeddings and the input embedding that may be associated with the set of images and the input image 210 respectively. The system 202 may generate a set of embeddings and the input embedding that may be associated with the set of images the input image 210 respectively. The system 202 may be configured to represent each embedding of the set of embeddings as a list of numerical values. By way of example, the image from the set of images and the input image 210 is represented by an embedding as [a, b . . . c, d]. In various embodiments, each letter out of [a, b . . . c, d] is a number representing a feature extracted from each image of the set of images and the input image 210.

In various embodiments, the system 202 may be configured to perform a set of operations for generation of the set of embeddings and the input embedding that may be associated with the set of images and the input image 210. For example, the set of operations for generation of the set of embeddings and the input embedding may correspond to, but is not limited to, the operations corresponding to a contrastive language image pretraining (CLIP) model to generate a set of embeddings and the input embedding for each image of the set of images and the input image 210. The CLIP model leverages a transformer-based architecture that integrates both vision and natural language processing tasks to create a unified embedding space for text and images. The model processes each image of the set of images and the input image 210 through a series of convolutional and attention-based layers to extract visual embeddings, while the input text is processed using a separate transformer-based text encoder. Each image of the set of images and the input image 210 is first preprocessed and passed through the image encoder, where each image of the set of images and the input image 210 is converted into a series of feature representations. The input text is tokenized and encoded into a sequence of tokens, which are transformed into feature representations through the text encoder. These visual and textual embeddings are then aligned in a shared latent space, where a multi-head attention mechanism adjusts the attention weights to correlate the semantic meaning of the text with the corresponding visual embeddings of the image. The result is a set of embeddings and the input embedding that represent both the visual content of each image of the set of images and the input image 210 and the textual content.

At 324, a similarity score calculation operation may be executed. In the calculation of the similarity score between input embedding and each embedding of the set of embeddings, the system 202 may be configured to calculate the similarity score between the input image 210 and each image of the set of images generated at 322. In various embodiments, the similarity score between each image of the set of images and the input image 210 may correspond to a numerical value indicative of similarity between the input image 210 and the image of the set of images generated at 322. In various embodiments, the similarity between each image of the set of images and the input image 210 is indicative of how alike a pair of images are in terms of their content, structure, or features.

In various embodiments, the system 202 may be configured to apply a similarity matrix on the set of embeddings generated at 324 to calculate a similarity score between the input image 210 and each image of the set of images generated at 322. Based on the application of the similarity matrix, the system 202 may calculate a similarity score between the input image 210 and each image of the set of images generated at 322. The system 202 may be configured to represent the similarity score as a numerical value.

In various embodiments, the similarity matrix may be a cosine similarity function to calculate a set of similarity scores between the input image 210 and each image of the set of images generated at 322. In various embodiments, applying a cosine similarity function to calculate a similarity score from the set of similarity scores between the input image 210 and an image from the set of images generated at 322. By way of an example, and not by limitation, where ‘x’ represents an embedding of the set of embeddings generated at 320 and ‘y’ represents the input embedding generated at 322, the cosine similarity function between each image from the set of images and the input image 210 may be represented by equation (1) as follow:

$$Cosine similarity ( x , y ) = \frac{x \cdot y}{‖ x ‖ ‖ y ‖} \qquad ( 1 )$$

where x.y represents the dot product the embedding of the set of embeddings ‘x’ and input embedding ‘y’, and
∥x∥ is the magnitude (or norm) of the embedding of the set of embeddings ‘x’, and calculated as

$$‖ x ‖ = \sqrt{{\sum }_{i = 1}^{n} {x}_{i}^{2}} ;$$

∥y∥ is the magnitude (or norm) of the input embedding ‘y’ and calculated as

$$‖ y ‖ = \sqrt{{\sum }_{i = 1}^{n} {y}_{i}^{2}} .$$

In various embodiments, the system 202 is configured to calculate a similarity score for each image from the set of images and the input image 210. By way of an example, and not by limitation, if one of the set of embeddings is represented as x=[0.12, 0.32, 0.42] and the input embedding is represented as y=[0.12, 0.31, 0.43], then the similarity score between one of the set of images corresponding to one of the set of embeddings and the input image may be calculated using the similarity score as:

$$x \cdot y = ( 0 \text{.12} \cdot 0.12 ) + ( 0.31 \cdot 0.32 ) + ( 0.43 \cdot 042 ) = 0.2942$$

$$‖ x ‖ = ( {( 0.12 )}^{2} + {( 0.31 )}^{2} + {( 0.43 )}^{2} = 0 \text{.5435}$$

$$‖ y ‖ = ( {( 0.12 )}^{2} + {( 0.32 )}^{2} + {( 0.42 )}^{2} = 0 \text{.5417}$$

$$Similarity score = \frac{x \cdot y}{‖ x ‖ ‖ y ‖} = \frac{0.2942}{0.5 \; 435 \times 0.5417} = 0.9997$$

At 326, an average similarity score calculation operation may be executed. In the calculation of an average similarity score, the system 202 may be configured to calculate an average similarity score based on the similarity score generated at 324 associated with the input image 210 and each image of the set of images. In various embodiments, the average similarity score may correspond to a numerical value representing a degree of similarity between the input image 210 and the set of images generated at 322.

In various embodiments, the system 202 may be configured to apply an averaging function on the similarity score between input embedding and each embedding of the set of embeddings to calculate the average similarity score between the input image 210 and the set of images. The system 202 may calculate an average similarity score between the input image 210 and the set of images using the averaging function The system 202 may be configured to represent an average similarity score as a numerical value.

In various embodiments, by way of an example, and not by limitation, the averaging function may be an average pairwise distance function to calculate the average similarity score between the input image 210 and each image of the set of images. In various embodiments the input image 210 and each image of the set of images. By way of an example, and not by limitation the formula for the average pairwise distance function may be represented by equation (2) as follows:

$$Average pairwise distance ( n ) = \frac{2}{n ( n - 1 )} \sum \vert {distance}_{i} - {distance}_{j} \vert \qquad ( 2 )$$

where n represents the total number of embeddings associated with the image,
distanceᵢ represents the cosine distance between i^{th} embedding of the set of embeddings generated at 324 and the input embedding,
distanceⱼ represents the cosine distance between j^{th} embedding of the set of embeddings generated at 324 and the input embedding, and
i and j represents a numerical value such that i≠j.

In various embodiments of the disclosure, the system 202 is configured to perform an operation of calculation of the average similarity score between the input image 210 and the set of images using the average pairwise function on the set of embeddings and the input embedding. By way of an example, not by limitation, the similarity score between three images from the set of images and the input image 210 may equal 0.9, 0.85, and 0.7 respectively. The system 202 may be configured to calculate the average similarity score using the average pairwise distance function (provided in equation (2)) as follows:

$$Average similarity score = \frac{2}{3 ( 3 - 1 )} ( \vert 0.9 - 0 \text{.85} \vert + \vert 0.9 - 0.7 \vert + \vert 0.85 - 0.7 \vert ) = 0.13$$

In various embodiments, the system 202 may be configured to compare the similarity score with a threshold value. The system 202 may be configured to determine a high similarity between the set of images and the input image where the average similarity score is less than a threshold value. By way of example, not by limitation, if the average similarity score between the set of images and the input image 210 is 0.13 and the threshold value is 0.2, then the similarity between the set of images and the input image 210 may be considered high indicative of the input image 210 being a simulated image.

At 328, a second result data generation operation is executed. In the second result data generation operation, the system 202 may be configured to generate the second result data based on the average similarity score generated at 326 between the input image 210 and the set of images. In various embodiments, the second result data may include a second label 330 a second set of reasons 332, and a second score 334.

In various embodiments, the second result data may include the second label 330 that represents a truth value for detecting whether the input image 210 is simulated or real. The system 202 may be configured to determine the second label 330 as true where the average similarity score calculated at 330 is less than the threshold value. In various embodiments, the threshold value is a numerical value.

In various embodiments, the second result data may include the second set of reasons 332 representing a statement for the degree of similarity between the input image 210 and the set of images, and the second score 334 that represents a numerical value. In an alternate embodiment, the system 202 may be configured to calculate the second score by the following expression: second score 334=1-average similarity score

In various embodiments, by way of an example, and not by limitation the second result data associated with the input image 210 may be represented as prompt:

```
  {
  ″Is-AI-Generated″: True,
    “reasons”: [” the similarity between input image and set of images is High ″],
    ″possibility″: 0.87
  }
where “Is-AI-Generated″: True” represents the second label 330,
“reasons” represents the second set of reasons 332,
“possibility” represents the second score 334.
```

FIG. 3C is a diagram that illustrates exemplary operations for generation of the third result data using machine learning models, in accordance with various embodiments of the disclosure. FIG. 3C is explained in conjunction with elements from FIG. 1, and FIG. 2. With reference to FIG. 3C, there is shown a block diagram 300C that illustrates exemplary operations from 336 to 346, as described herein. The exemplary operations illustrated in the block diagram 300C may start at 336 and may be performed by any computing system, apparatus, or device, such as by the computer 102 of FIG. 1 or system 202 of FIG. 2. Although illustrated with discrete blocks, the exemplary operations associated with one or more blocks of the block diagram 300C may be divided into additional blocks, combined into fewer blocks, or eliminated, depending on the implementation.

At 336, one or more pre-processing operations on the input image 210 may be executed. The system 202 may be configured to perform the one or more pre-processing of the input image 210. In various embodiments, the one or more pre-processing of the input image 210 may include but is not limited to, resizing and normalization of the input image 210, color space conversion of the input image 210, noise reduction of the input image 210, edge enhancement of the input image 210 and patch generation of the input image 210.

In various embodiments, the system 202 may be configured to perform the one or more pre-processing operations on the image. For example, the one or more pre-processing operations may correspond to but is not limited to, the operations corresponding to a convolutional neural network (CNN), deep bilinear convolution neural network (DB-CNN), and gaussian mixture models (GMM) to identify and correct inconsistencies in the input image. For example, CNN may be leveraged by algorithms such as document image quality assessment (DIQA), ranking-based image quality assessment (RankIQA), and hyperspectral image quality assessment (HIQA). GMM may segment the image into distinct regions for localized preprocessing, ensuring that each part of the image receives tailored processing based on its unique characteristics.

In various embodiments, the system 202 may be configured to apply the one or more pre-processing operations. For example, the one or more pre-processing operations may correspond, but are not limited to, the operations corresponding to K-means clustering and principal component analysis (PCA) to identify underlying patterns in the image. For example, K-means clustering may be employed by algorithms such as multi-symbol differential detection (MSDD) and DIQA to group similar pixel intensities to detect homogeneous regions and outliers. PCA may reduce dimensionality by extracting the most significant embeddings. These algorithms contribute to preprocessing by optimizing the image.

In various embodiments, the system 202 may be configured to apply the one or more pre-processing operations. For example, the one or more pre-processing operations may correspond to but are not limited to, image quality assessment (NR-IQA) algorithms such as blind reference less image spatial quality evaluator (BRISQUE), multi-task end-to-end optimized deep neural network (MEON) and generative adversarial network (GAN) based models. These algorithms may provide output in the form of preprocessed image that aligns with the input requirements of the quality assessment algorithms. By leveraging a diverse set of ML techniques for preprocessing, the third ML model 212C ensures accurate image quality assessment.

At 338, a set of features extraction may be executed. In the extraction of the set of features, the system 202 may be configured to extract the set of features that may be associated with the input image 210. Each feature of the set of features may correspond to a value representing the quality of the image. In various embodiments, the set of features may include but are not limited to, statistical embeddings of the input image 210 such as mean value, variance value, and standard deviation value, texture and structure embeddings of the input image 210 such as mean gradient value and entropy value and perceptual quality metrics of the input image 210 such as natural image quality evaluator (NIQE) score and visual information fidelity (VIF) score.

In various embodiments, the system 202 may be configured to apply a set of extractors on the input image 210 to extract a set of features. In various embodiments, each extractor of the set of extractors depends on the one or more pre-processing operations the system 202 is configured to apply on the input image 210. Each extractor of the set of extractors may include but is not limited to, mean, variance, standard deviation, mean gradient, entropy, perceptual quality metrics, NIQE, and VIF. By way of an example, and not by limitation the system 202 may be configured to apply the one or more pre-processing operations corresponding to the GAN model. Based on the application of the GAN model, the system 202 may be configured to apply the set of extractors that may include but are not limited to CNN, inception network, Sobel edge detector, Laplacian of Gaussian, and Alex Net on the input image 210 to generate a set of embeddings.

At 346, an image analysis operation may be executed. In the analysis of the input image 210 based on a set of quality indicators, the system 202 may be configured to classify the input image 210 based on a set of quality indicators. In various embodiments, each quality indicator of the set of quality indicators corresponds to a parameter measuring the quality of the input image 210. Each quality indicator of the set of quality indicators may include, but is not limited to a blurry image, abnormal backgrounds, over-rendering, sharp appearance, individual hairs, non-flubbed details, garbled text, noise detected, and watermark on the input image 210.

In various embodiments, the system 202 may be configured to input a set of features extracted at 344 to a classifier to classify the input image 210 based on a set of quality indicators. In various embodiments, a classifier may be configured to analyze the set of features extracted at 344. The classifier evaluates the set of features and classifies the input image 210 in a set of quality indicators. In various embodiments, by way of example, not by limitation, if the system 202 is configured to apply the CNN model on the image as the classifier, then the set of features extracted may correspond to blurry levels, noise patterns, color balance, or the like.

In various embodiments, the classifier may be trained using a supervised learning approach based on the second dataset 216. The second dataset 216 may be indicative of the annotated pairs of image embeddings and corresponding quality indicators. The training process involves multiple iterations. During each iteration, the classifier processes the extracted embeddings through a learning algorithm. The learning algorithm may include but is not limited to, a decision tree, a support vector machine, and a deep neural network. The model is trained using a classification loss function, where the goal is to minimize the discrepancy between the predicted and ground-truth quality indicators. In various embodiments of the disclosure, the system 202 is configured to classify the input image 210 in the set of quality indicators based on the application of a plurality of ML models on data.

At 342, a set of ratings generation operation may be executed. In the generation of the set of ratings, the system 202 may be configured to generate a set of ratings that may be associated with the input image 210. In various embodiments, each rating of the set of ratings may correspond to a numerical value representing the measure of the presence of at least one quality indicator in the input image 210.

In various embodiments, the system 202 may be configured to generate a set of ratings based on a set of benchmarks 344 associated with a set of quality indicators. The system 202 may be configured to generate a set of ratings associated with each quality indicator of the set of quality indicators based on the set of features and the set of benchmarks 344. In various embodiments, each benchmark of the set of benchmarks 344 may include, but is not limited to a numerical value representing the measure of the presence of at least a quality indicator in the input a plurality of images stored in the second dataset 216 on which model is trained.

At 346, the third result data generation operation is executed. In the third result data generation operation, the system 202 may be configured to generate the third result data based on the generation of the set of ratings. In various embodiments, the third result data may include a third label 348 a third set of reasons 350, and a third score 352.

In various embodiments, the third result data may include the third label 348 that represents a truth value for detecting whether the input image 210 is simulated or real. The system 202 may be configured to determine the third label 348 based on the set of ratings generated at 342 that may be associated with the set of quality indicators on which the input image 210 is analyzed at 340. By way of example, not by limitation, if the set of quality indicators for the input image 210 may include a watermark, image blurry, abnormal backgrounds, and sharp appearance associated with the set of ratings corresponding to 0, 0.01, 0, and 0 respectively, then the third label 348 may be ‘false’ based on the ratings associated with the set of quality indicators.

In various embodiments, the third result data may include the third set of reasons 350 representing a statement based on the set of ratings that may be associated with the set of quality indicators in which the input image 210.

In various embodiments, the third result data may include the third score 352 that represents a weighted average of each rating of the set of ratings that may be associated with the set of quality indicators in which the input image 210. In various embodiments, by way of example, not by limitation, the weighted average expression may be provided by equation (3) as follows:

$$Weighted Average = \frac{\sum ( {R}_{i} \cdot {W}_{i} )}{\sum {R}_{i}} \qquad ( 3 )$$

where n represents a count of the set of quality indicators,
Rᵢ represents the i^{th} rating set of ratings, and
Wᵢ represents the i^{th} benchmark of the set of benchmarks.

In various embodiments, by way of an example, and not by limitation the third result data associated with the input image 210 may be represented as prompt:

```
  {
″Is-AI-Generated″: False,
    “reasons”: [” The images visually realistic ″],
    ” Possibility″: 0.45
}
where “Is-AI-Generated″: True” represents the third label 348,
“reasons” represents the third set of reasons 350,
“possibility” represents the third score 352.
```

FIG. 3D is a diagram that illustrates first exemplary operations for generation of the third result data using machine learning models, in accordance with various embodiments of the disclosure. FIG. 3D is explained in conjunction with elements from FIG. 1, and FIG. 2. With reference to FIG. 3D, there is shown a block diagram 300D that illustrates exemplary operations from 320, as described herein. The exemplary operations illustrated in the block diagram 300D may start at 320 and may be performed by any computing system, apparatus, or device, such as by the computer 102 of FIG. 1 or system 202 of FIG. 2. Although illustrated with discrete blocks, the exemplary operations associated with one or more blocks of the block diagram 300D may be divided into additional blocks, combined into fewer blocks, or eliminated, depending on the implementation.

At 356, a prompt generation operation may be executed. The system 202 may be configured to generate a prompt from the first result data generated at 310 based on the input image 210, the second result data generated at 328 based on the summary data, and the third result data generated at 348 based on the input image 210.

In various embodiments, the system 202 may be configured to apply the third ML model 212C on the first result data, the second result data, and the third result data to generate a prompt. Based on the application of the third ML model 212C from the set of ML models 212, the system may generate the prompt. By way of example, not by limitation, the third ML model 212C may be a large language model (LLM) to integrate the first result data, the second result data, and the third result data and generate a prompt.

In various embodiments, the system 202 may be configured to generate a prompt. The prompt may correspond to a JavaScript object notation (JSON) file. The JSON file is a lightweight data-interchange format used to store and exchange structured data. A JSON file consists of key-value pairs organized into objects and arrays. The keys are strings and values may be strings, numbers, Booleans, arrays, objects, or null.

In various embodiments, the third ML model 212C of the set of ML models 212 on the summary data of the input image 210 may be trained using a supervised learning approach based on the second dataset 216. The second dataset 216 may be indicative of the text data, dialogue data, programming code, structured data, and domain-specific data. The training process involves multiple iterations where the model iteratively refines its predictions to enhance detection accuracy. In various embodiments of the disclosure, the system 202 is configured to perform an operation of generation of the prompt based on the application of a plurality of ML models on data.

At 358, a final result data generation operation may be executed. The system 202 may be configured to generate a final result from the generated prompt based on the first result data generated at 310 based on the input image 210 that may be received at 302, the second result data generated at 328 based on the generation of the summary data 320 associated with the input image 210 received at 302 and the third result data generated at 348 based on the input image 210 that may be received at 302 based on one or more criteria 354.

FIG. 3E is a diagram that illustrates second exemplary operations for generation of the final result based on the one or more criteria 354, in accordance with various embodiments of the disclosure. FIG. 3E is explained in conjunction with elements from FIG. 1, and FIG. 2. With reference to FIG. 3E, there is shown a block diagram 300D that illustrates exemplary operations from 360 to 376, as described herein. The exemplary operations illustrated in the block diagram 300D may start at 360 and may be performed by any computing system, apparatus, or device, such as by the computer 102 of FIG. 1 or system 202 of FIG. 2. Although illustrated with discrete blocks, the exemplary operations associated with one or more blocks of the block diagram 300E may be divided into additional blocks, combined into fewer blocks, or eliminated, depending on the implementation.

At 360, the system 202 may determine whether the two of a set of labels are true. In various embodiments, the set of labels may include the first label 312, the second label 330, and the third label 348. By way of an example, and not by limitation if two of the first label 312, the second label 330, and the third label 348 are true, then the input image 210 is detected as simulated image 364. Otherwise, then the input image 210 that may be received as the input at 302 is detected as real image 362. In various embodiments, the system 202 may be configured to determine a final label 378 based on two of the first label 312, the second label 330, and the third label 348. By way of an example, and not by limitation if two of the first label 312, the second label 330, and the third label 348 are true, then the final label 378 is true. Each label of the set of labels is associated with a set of truth values. The set of truth values may include a first truth value representing true and a second truth value representing false.

At 366, a determination of a final score operation may be executed. The system 202 may be configured to determine a final score 382 based on whether the two of the labels correspond to one of the set of truth values. In various embodiments, the system 202 may be configured to determine the final score 382 by calculating the average of two scores of two of the set of labels corresponding to one of the set of truth values. By way of an example, and not by limitation if the first label 312 is true and associated with the first score 316 equal to 0.95 and the second label 330 is true and associated with the second score 334 equals 0.87, then the final score 382 is determined as (0.95+0.87)/2 equals 0.91.

At 368, determination of the final set of reasons operation may be executed. The system 202 may be configured to determine a final set of reasons 380 based on whether the two of the set of labels correspond to one of the set of truth values. In various embodiments, the system 202 may be configured to determine the final set of reasons 380 by combining the set of reasons associated with the two of the set of labels corresponding to one of the set of truth values. By way of an example, and not by limitation if the first label 312 is true and the second label 330 is true, then the final set of reasons 380 is determined as a combination of the first set of reasons 314 and the second set of reasons 332.

At 370, the system 202 may determine whether the first label 312 is true. By way of an example, and not by limitation if the first label 312 is false, then the input image 210 is detected as real image 362. If the first label 312 is true, then the computer system 202 may be configured to proceed the flow of operations to 372.

At 372, the system 202 may determine whether the first set of reasons 314 includes at least three statements. By way of an example, and not by limitation if the first set of reasons 314 includes at least three statements, then the input image 210 that may be received at 302 is detected as simulated image 364. Otherwise, the input image 210 that may be received at 302 is detected as real image 362.

At 374 a determination of the first score as the final score operation may be executed. The system 202 may be configured to determine the final score 382 based on whether the first label 312 corresponds to at least a value from the set of truth values. In various embodiments, the system 202 may be configured to determine a score as the first score. By way of an example, and not by limitation if the first label 312 is true and is equal to 0.95, then the final score 382 is determined as 0.95.

At 376, determination of the final set of reasons as the first set of reasons 314 operation may be executed. The system 202 may be configured to determine the final set of reasons 380 based on whether the first label 312 corresponds to at least a value from the set of truth values. In various embodiments, the system 202 may be configured to determine the final set of reasons 380 as the first set of reasons 314. By way of an example, and not by limitation if the first label 312 is true, then the final set of reasons 380 is determined as the first set of reasons 314.

In various embodiments, the final result data may include the final label 378, the final set of reasons 380, and the final score 382. By way of an example, and not by limitation if the final label 378 is true and equals 0.95 and the second label 330 is true and equals 0.87, then the final result data associated with the input image 210 that may be received at 302 may be represented as a prompt:

```
{
  ″Is-AI-Generated″: True,
    “reasons”: [
    {
      “reason”: ″People usually don't wear T-shirts in snowy conditions”,
      “view”: “logic”
    },
    {
    “reason”: ″ Trees in the background have no leaves, indicating it's winter, yet the person
  is not dressed for the season”,
    “view″: “logic″
    },
    {
    “reason”: ″ The similarity between the input image and AI-generated image is High”,
    “view”: “Algorithm”
    }
    ],
      “possibility”: 0.91
}
where “Is-AI-Generated″: True” is the final label 378 representing the input image 210 is a
simulated image,
  “reasons” represents the final set of reasons 380,
  “possibility” represents the final score 382.
```

FIG. 4A is a diagram that illustrates an exemplary first user interface for data quality estimation using machine learning (ML) models, in accordance with various embodiments of the disclosure. FIG. 4A is explained in conjunction with elements from FIG. 1, FIG. 2, FIG. 3A, FIG. 3B, FIG. 3C, FIG. 3D, and FIG. 3E. With reference to FIG. 4A, there is shown an exemplary diagram 400A that includes a user device 208 and an exemplary input page 404. The exemplary input page 404 includes a first user interface (UI) element 406, a second UI element 408, and a third UI element 410. The user device 208 is an exemplary embodiment of the user device 208 of FIG. 2.

With reference to FIG. 4A, the system 202 receives the input image 210 as the input from the user device 208. The user device 208 includes a display unit (a user interface) that renders the exemplary input page 404 to the first entity 222. The system 202 renders the exemplary input page 404 on the user interface (UI) of the user device 208. The exemplary input page 404 corresponds to a web page or online form that is designed to collect information from entities who wish to estimate the quality score of their datasets. In various embodiments of the disclosure, the exemplary input page 404 is used to obtain the input image 210 as the input.

The first UI element 406 corresponds to a textbox that includes a message for first entity 222, for example, “Enter Your Data”. The first UI element 406 further includes the second UI element 408. The second UI element 408 corresponds to a button and is labeled as “Upload Files”. Upon selecting the second UI element 408, the first entity 222 is asked to provide the input image 210 in the form of a file, for example, joint photographic experts group (JPEG), portable network graphics (PNG), Bitmap image file (BMP), tagged image file format (TIFF), or the like. Then, the system 202 obtains the input image 210 upon providing the file.

The third UI element 410 corresponds to a button and is labeled as “Submit”. Upon selecting the third UI element 410, the system 202 receives the and further initiates the result generation. For example, the system 202 performs the result generation operation 360 upon selecting the third UI element 410. Details about the result generation operation are provided, for example, in FIG. 3D.

FIG. 4B is a diagram that illustrates an exemplary second user interface for data quality estimation using machine learning (ML) models, in accordance with various embodiments of the disclosure. FIG. 4B is explained in conjunction with elements from FIG. 1, FIG. 2, FIG. 3A, FIG. 3B, FIG. 3C, FIG. 3D, and FIG. 3E. With reference to FIG. 4B, there is shown an exemplary diagram 400B that includes the user device 208 and an exemplary output page 412. The exemplary output page 412 includes a fourth UI element 414 and a fifth UI element 416.

With reference to FIG. 4B, the system 202 renders the exemplary output page 412 on the display unit (or the user interface) of the user device 208 based on the generation of the result associated with the input image 210. The system 202 renders the result associated with the input image 210 on the exemplary output page 412.

The fourth UI element 414 corresponds to a textbox that includes a message that indicates the quality score associated with the input dataset. In an exemplary embodiment of the disclosure, the message may be, for example,

```
Is-AI-Generated″: True,
  “reasons”: [
      {
        “reason”: ″People usually don't wear T-shirts in snowy conditions”,
        “view”: “logic”
      },
    {
      “reason”: ″ Trees in the background have no leaves, indicating it's winter, yet the
  person is not dressed for the season”,
    “view”: “logic”
      },
    {
      “reason”: ″ The similarity between the input image and AI-generated image is
    High”,
      “view”: “Algorithm”
  }
  ],
    “possibility”: 0.91
```

The fifth UI element 416 corresponds to a button and is labeled as “Back”. In an embodiment of the disclosure, the system 202 renders the exemplary input page 404 on the user interface of the user device 208 upon selecting the fifth UI element 416.

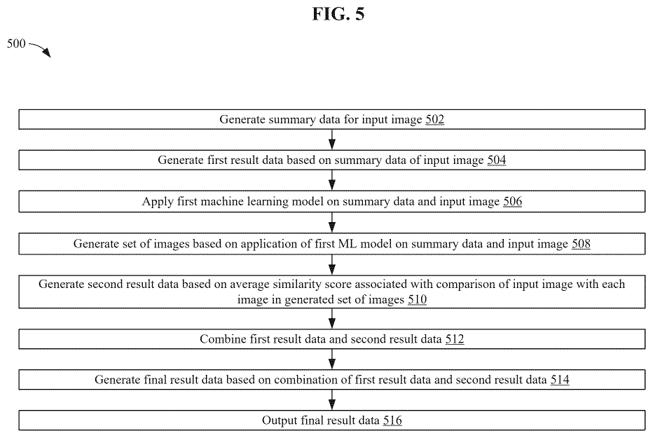

FIG. 5 is a diagram that illustrates a flowchart of an exemplary first method for detection of simulated images using machine learning, in accordance with various embodiments of the disclosure. FIG. 7 is explained in conjunction with elements from FIG. 1, FIG. 2, FIG. 3A, FIG. 3B, FIG. 3C, FIG. 3D, FIG. 3E, FIG. 4A and FIG. 4B. With reference to FIG. 5, there is shown a flowchart 500. The operations of the exemplary method may be executed by any computing system, for example, by the computer 102 of FIG. 1 or the system 202 of FIG. 2. The operations of the flowchart 500 may start at 502.

At 502, the summary data of the input image 210 is generated. The summary data of the input image 210 corresponds to a set of statements that represent a description of the input image 210. In various embodiments of the disclosure, the system 202 generates the summary data of the input image 210 based on the application of the second ML model 212B of the set of ML models 212. The summary data of the input image 210 corresponds to a set of statements that represent a description of the input image 210. Details about the generation of the summary data of the input image 210 operation are provided, for example, in FIG. 3A.

At 504, the first result data is generated based on the summary data of the input image 210 generated at 502. The first result data includes the first label 312, the first set of reasons 314, and the first score 316. In various embodiments of the disclosure, the system 202 generates the first result data based on the summary data of the input image 210. Details about the generation of the first result data operation are provided, for example, in FIG. 3A.

At 506, the first ML model 212A of the set of ML models 212 is applied to the summary data and the input image 210. In various embodiments, the first ML model may correspond to a multimodal model. Details about the application of the first ML model on the summary data generated at 502 and the input image 210 are provided, for example, in FIG. 3B.

At 508, the set of images is generated based on the application of the first ML model 212A of the set of ML models 212 at 506 on the summary data of the input image 210. Each image of the set of images includes an image contextually relevant to the summary data of the input image 210. In various embodiments of the disclosure, the system 202 generates a set of images from the summary data of the input image 210. Each image of the set of images includes an image contextually relevant to the summary data of the input image 210. Details about the generation of the set of images operations are provided, for example, in FIG. 3B.

At 510, the second result data is generated based on the average similarity score. The second result data includes the second label 330, the second set of reasons 332, and the second score 334. In various embodiments of the disclosure, the system 202 generates the second result data based on the average similarity score. In various embodiments of the disclosure, the system 202 calculates the average similarity score between each of the set of images and the input image 210. The average similarity score corresponds to a numerical value representing a degree of similarity between the input image 210 and the set of images. Details about the generation of the second result data operation are provided, for example, in FIG. 3B.

At 512, the first result data and the second result data are combined. In various embodiments of the disclosure, the combination of the first result data and the second result data is based on the one or more criteria 354. Details about the combination of the first result data and the second result data operation are provided, for example, in FIG. 3E.

At 514, a final result is generated. In various embodiments of the disclosure, the final result is generated based on the combination of the first result data and the second result data at 512. Details about the generation of the final result based on the combination of the first result data and the second result data operation are provided, for example, in FIG. 3E.

At 516, the final result is outputted. In various embodiments of the disclosure, the final result is outputted based on the generation of the final result at 514. Details about outputting the final result data operation are provided, for example, in FIG. 3D.

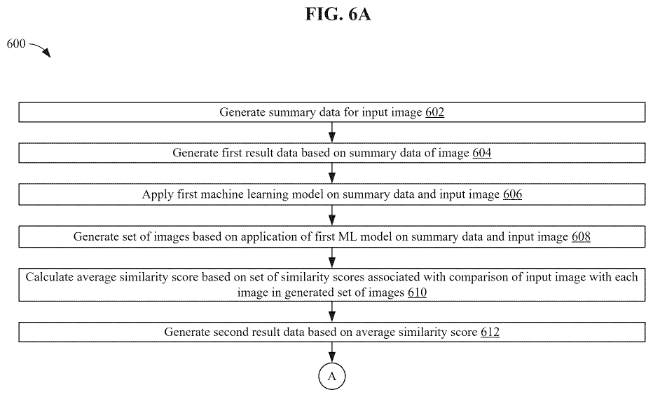

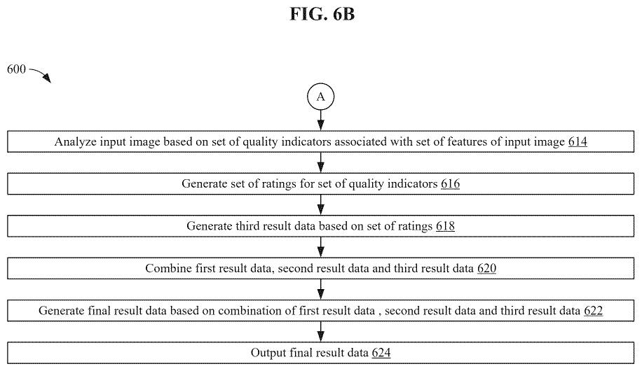

FIGS. 6A and 6B are diagrams that collectively illustrates a flowchart of an exemplary second method for detection of simulated images using machine learning, in accordance with various embodiments of the disclosure. FIG. 7 is explained in conjunction with elements from FIG. 1, FIG. 2, FIG. 3A, FIG. 3B, FIG. 3C, FIG. 3D, FIG. 3E, FIG. 4A, FIG. 4B, and FIG. 5. With reference to FIGS. 6A and 6B, there is shown a flowchart 600. The operations of the exemplary method may be executed by any computing system, for example, by the computer 102 of FIG. 1 or the system 202 of FIG. 2. The operations of the flowchart 600 may start at 602.

At 602, the summary data of the input image 210 is generated. The summary data of the input image 210 corresponds to a set of statements that represent a description of the input image 210. In various embodiments of the disclosure, the system 202 generates the summary data of the input image 210. The summary data of the input image 210 corresponds to a set of statements that represent a description of the input image 210. Details about the generation of the summary data of the input image 210 operation are provided, for example, in FIG. 3A.

At 604, the first result data is generated based on the summary data of the input image 210 generated at 602. The first result data includes the first label 312, the first set of reasons 314, and the first score 316. In various embodiments of the disclosure, the system 202 generates the first result data based on the summary data of the input image 210. The first result data includes the first label 312, the first set of reasons 314, and the first score 316. Details about the generation of the first result data operation are provided, for example, in FIG. 3A.

At 606, the first ML model 212A of the set of ML models 212 is applied to the summary data and the input image 210. In various embodiments of the disclosure, the first ML model 212A of the set of ML models 212 may correspond to a multimodal model. Details about the application of the first ML model on the summary data and the input image 210 are provided, for example, in FIG. 3B.

At 608, the set of images is generated based on the application of the first ML model 212A of the set of ML models 212 at 606 on the summary data of the input image 210. Each image of the set of images includes an image contextually relevant to the summary data of the input image 210. In various embodiments of the disclosure, the system 202 generates a set of images from the summary data of the input image 210. Each image of the set of images includes an image contextually relevant to the summary data of the input image 210. Details about the generation of set of images operations are provided, for example, in FIG. 3B.

At 610, the average similarity score is calculated. In various embodiments of the disclosure, the system 202 calculates the average similarity between each of the set of images generated at 608 and the input image 210. The average similarity score corresponds to a numerical value representing a degree of similarity between the input image 210 and the set of images. Details about the calculation of average similarity score operation are provided, for example, in FIG. 3B.

At 612, the second result data is generated based on the average similarity score. The second result data includes the second label 330, the second set of reasons 332, and the second score 334. In various embodiments of the disclosure, the system 202 generates the second result data based on the average similarity score. Details about the generation of the second result data operation are provided, for example, in FIG. 3B.

At 614, the input image 210 is analyzed based on the set of quality indicators associated with the set of features of the input image 210. Each quality indicator of the set of quality indicators corresponds to a parameter measuring the quality of the image. In various embodiments of the disclosure, the system 202 analyzes the image in the set of quality indicators. Details about the analysis of the input image 210 based on a set of quality indicators operations are provided, for example, in FIG. 3C.

At 616, the set of ratings is generated for the set of quality indicators of the input image 210 analyzed at 614. Each rating of the set of ratings may correspond to a numerical value representing the measure of the presence of at least one quality indicator of the set of quality indicators in the input image 210. In various embodiments of the disclosure, the system 202 generates the set of ratings for the set of quality indicators of the input image 210. Details about the generation of the generation of the set of ratings for the set of quality indicators operation are provided, for example, in FIG. 3C.

At 618, the third result data is generated based on the set of ratings. The third result data includes the third label 348, the third set of reasons 350, and the third score 352. In various embodiments of the disclosure, the system 202 generates the third result data based on the set of ratings. Details about the generation of the third result data operation are provided, for example, in FIG. 3C.

At 620, the first result data, the second result data, and the third result data are combined. In various embodiments, the combination of the first result data, the second result data, and the third result data is based on one or me criteria 354. Details about the combination of the first result data, the second result data, and the third result data operation are provided, for example, in FIG. 3D.

At 622, the final result is generated based on the combination of the first result, the second result data, and the third result data at 620. The final result data includes the final label 378, the final set of reasons 380, and the final score 382. In various embodiments of the disclosure, the system 202 generates the result based on the combination of the first result, the second result data, and the third result data. Details about the generation of the final result data operation are described, for example, in reference to FIG. 3D and FIG. 3E.

At 624, the final result is outputted based on the generation of the final result at 622. Details about the outputting of the final result data operation are described, for example, in reference to FIG. 3E.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating, by a computer, summary data for an input image;
generating, by the computer, first result data based on the summary data, wherein the first result data comprises a first set of reasons associated with validation of a representational accuracy of the input image;
applying, by the computer, a first machine learning (ML) model on the summary data and the input image;
generating, by the computer, a set of images based on the application of the first ML model on the summary data and the input image;
generating, by the computer, second result data based on an average similarity score associated with a comparison of the input image with each image in the generated set of images;
combining, by the computer, the first result data and the second result data to generate final result data; and
outputting, by the computer, the final result data.

2. The computer-implemented method of claim 1, further comprising:
identifying, by the computer, a set of positions associated with a set of objects in the input image;
generating, by the computer, the summary data of the input image based on the identification of the set of positions associated with the set of objects in the input image;
applying, by the computer, a second machine learning model on the summary data; and
generating, by the computer, the first set of reasons based on the application of the second machine learning model on the summary data.

3. The computer-implemented method of claim 1, wherein the first result data further comprises at least one of a label assigned to the input image or a score associated with the assignment of the label to the input image.

4. The computer-implemented method of claim 3, wherein the label is indicative of the input image being one of a real image or a simulated image.

5. The computer-implemented method of claim 1, further comprising:
generating, by the computer, an input embedding associated with the input image;
generating, by the computer, a set of embeddings associated with the generated set of images;
calculating, by the computer, a similarity score indicative of a similarity between the input embedding and each embedding of the set of embeddings;
calculating, by the computer, the average similarity score indicative of the similarity between the input image and the set of images based on the calculated similarity score between the input embedding and each embedding of the set of embeddings; and
generating, by the computer, the second result data based on the calculated average similarity score.

6. The computer-implemented method of claim 5, wherein the second result data comprises at least one of a label assigned to the input image, a score associated with the assignment of the label to the input image, or a second set of reasons associated with the assignment of the label to the input image.

7. The computer-implemented method of claim 1, further comprising:
applying, by the computer, one or more pre-processing operations on the input image;
extracting, by the computer, a set of features from the input image based on the application of the one or more pre-processing operations on the input image;
analyzing, by the computer, the input image based on a set of quality indicators associated with the set of features;
generating, by the computer, a set of ratings for the set of quality indicators, wherein each rating of the set of ratings is indicative of a presence of a corresponding quality indicator of the set of quality indicators in the input image; and
generating, by the computer, third result data based on the set of ratings.

8. The computer-implemented method of claim 7, wherein the third result data comprises at least one of a label assigned with the input image, a score associated with the assignment of the label to the input image, or a third set of reasons associated with the assignment of the label to the input image.

9. The computer-implemented method of claim 8, further comprising:
generating, by the computer, a prompt based on the first result data, the second result data, the third result data, and one or more criteria;
applying, by the computer, a language model on the generated prompt;
determining, by the computer, the final result data based on the application of the language model on the generated prompt; and
outputting, by the computer, the determined final result data.

10. The computer-implemented method of claim 9, further comprising:
classifying, by the computer, the input image as one of a real image or a simulated image based on the determined final result data; and
outputting, by the computer, the classified input image.

11. A computer system, comprising:
a processor set;
one or more computer-readable storage media; and
program instructions stored on the one or more computer-readable storage media, the program instructions executable by the processor set to cause the processor set to:
generate summary data for an input image;
generate first result data based on the summary data, wherein the first result data comprises a first set of reasons associated with validation of a representational accuracy of the input image;
apply a first machine learning (ML) model on the summary data and the input image;
generate a set of images based on the application of the first ML model on the summary data and the input image;
generate second result data based on an average similarity score associated with a comparison of the input image with each image in the generated set of images;
analyze the input image based on a set of quality indicators associated with a set of features of the input image;
generate a set of ratings for the set of quality indicators, wherein each rating of the set of ratings is indicative of a presence of a corresponding quality indicator in the input image;
generate third result data based on the set of ratings;
combine the first result data, the second result data and the third result data to generate final result data; and
output the final result data.

12. The computer system of claim 11, wherein the program instructions further cause the processor set to:
identify a set of positions associated with a set of objects in the input image;
generate the summary data of the input image based on the identification of the set of positions associated with the set of objects in the input image;
apply a second machine learning model on the summary data; and
generate the first set of reasons based on the application of the second machine learning model on the summary data.

13. The computer system of claim 11, wherein the first result data further comprises at least one of a label assigned to the input image or a score associated with the assignment of the label to the input image.

14. The computer system of claim 13, wherein the label is indicative of the input image being one of a real image or a simulated image.

15. The computer system of claim 11, wherein to generate the second result data, the processor set is further caused to:
generate an input embedding associated with the input image;
generate a set of embeddings associated with the generated set of images;
calculate a similarity scores indicative of a similarity between the input embedding and each embedding of the set of embeddings;
calculate the average similarity score indicative of the similarity between the input image and the set of images based on the calculated similarity score between the input embedding and each embedding of the set of embeddings; and
generate the second result data based on the calculated average similarity score.

16. The computer system of claim 15, wherein the second result data comprises at least one of a label assigned to the input image, a score associated with the assignment of the label to the input image, or a second set of reasons associated with the assignment of the label to the input image.

17. The computer system of claim 11, wherein the program instructions further cause the processor set to:
apply one or more pre-processing operations on the input image;
extract the set of features from the input image based on the application of the one or more pre-processing operations on the input image;
analyze the input image based on the set of quality indicators associated with the set of features;
generate a set of ratings for the set of quality indicators; and
generate the third result data based on the set of ratings.

18. The computer system of claim 17, wherein the third result data comprises at least one of a label assigned to the input image, a score associated with the assignment of the label to the input image, or a third set of reasons associated with the assignment of the label to the input image.

19. The computer system of claim 11, wherein the program instructions further cause the processor set to:
generate a prompt based on the first result data, the second result data, the third result data, and one or more criteria;
apply a language model on the generated prompt;
determine the final result data based on the application of the language model on the generated prompt;
classify the input image as one of a real image or a simulated image based on determined final result data; and
output the classified input image.

20. A computer-program product for classifying an input image as a real image or a simulated image, the computer-program product comprising:
one or more computer-readable storage media; and
program instructions stored on the one or more computer-readable storage media to perform operations comprising:
generating summary data for the input image;
generating first result data based on the summary data, wherein the first result data comprises a first set of reasons associated with validation of a representational accuracy of the input image;
applying a first machine learning (ML) model on the summary data and the input image;
generating a set of images based on the application of the first ML model on the summary data and the input image;
generating second result data based on an average similarity score associated with a comparison of the input image with each image in the generated set of images;
combining the first result data and the second result data to generate final result data;
classifying the input image as one of the real image or the simulated image based on the final result data; and
output the classified input image.
